(19) United States
(12) Patent Application Publication
(10) Pub. No.: US 2012/0067694 A1
(43) Pub. Date: Mar. 22, 2012

(54) PRODUCT REDISTRIBUTION APPARATUS

(75) Inventor: Kurt Philipp, Grenzach-Wyhlen (DE)

(73) Assignee: ROTZINGER AG, Kaiseraugst (CH)

(21) Appl. No.: 13/266,046

(22) PCT Filed: Apr. 23, 2010
(86) PCT No.: PCT/IB10/51789

§ 371 Date: Oct. 24, 2011

(30) Foreign Application Priority Data
Apr. 23, 2009 (CH) 00643/09

(51) Int. Cl. B65G 47/46

(52) U.S. Cl. 198/369.2

(57) ABSTRACT

A product redistribution device, including a pivotable main conveyor for conveying products, a storage apparatus for receiving the products at an input location and for outputting the temporarily stored products at a drop-off location, wherein the products can be pushed out at the drop-off location by a pushing device of the storage apparatus, wherein a discharge conveyor is available for receiving the pushed out products, wherein the product redistribution device includes a decoupling apparatus and a load conveyor for temporarily storing the products.

This invention relates to a product redistribution apparatus as set forth in the preamble of independent claim 1, and to a corresponding method.

### DESCRIPTION

Apparatuses for redistributing products are known from the prior art. For example, published document EP 0534902 A1 relates to a method for feeding products to a buffer and to a buffer feeding device for feeding products into a buffer, and to a buffer feeding device operating according to this method that provides an increased loading rate for the products.

One disadvantage of the invention, however, is the fact that all of the products must pass through the buffer before they can be fed to a packaging machine. The requirement is thus that the buffer must first contain a certain base stock of products before these can then be pushed out. Another disadvantageous factor is that time is lost in this process during which the products are being conveyed through the buffer, outputted, and fed to the packaging machine. Another disadvantage is that the buffer must be emptied for a relatively long time period when production is stopped. Another disadvantage found is that the production cycle rate and the cycle rate for the packaging machine, which typically differ, can only be synchronized at low production rates or at a low production speed.

The object of this invention is therefore to provide an apparatus and a corresponding method for redistributing and decoupling the products coming from continuous production, wherein the products can be fed, for example, to a packaging machine and/or a buffer device. In particular, the goal is to ensure a continuous uninterrupted conveyance of products to a packaging machine. The invention should enable the throughput of the products to be optimized.

In particular, the goals of the invention are achieved by a product redistribution apparatus, comprising a swivelable main conveyor to convey products in a main conveyance direction between an input location and a delivery location, wherein the delivery location of the main conveyor is swivelable into multiple transfer positions, comprising a buffer device that includes multiple stacked tray levels to receive the products at an input location and to deliver the temporarily stored products at a delivery location, wherein the input location of the buffer device can be positioned at one of the transfer positions and wherein the products at the delivery location can be pushed out by a pushing means of the buffer device, wherein a discharge conveyor is provided to receive the pushed-out products at a first input location and to deliver the products at a delivery location of the discharge conveyor, wherein the delivery location of the buffer device is connected to the first input location of the discharge conveyor, wherein the product redistribution apparatus comprises a decoupling device with an input location to receive products from the main conveyor at a first transfer position and a delivery location to deliver the products, wherein the delivery location of the decoupling device is connected to a second input location of the discharge conveyor, wherein the product redistribution apparatus comprises a loading conveyor to convey the products between an input location and a delivery location, wherein the input location can be connected to the delivery location of the main conveyor at a second transfer position and wherein at one of the multiple transfer positions the delivery location of the loading conveyor can be connected to the input location of the buffer device in order to temporarily store products on a corresponding tray level. The product redistribution apparatus provided between a production station and a packaging station is designed to redistribute products to multiple tray levels, shelves, conveyors, etc., so as to enable products to be fed in an uninterrupted stream or flow, in particular, to the packaging station.

One advantage of the invention is the fact that products that are preferably transported on the main conveyor in rows are also transferred to the decoupling unit or device—alternatively or additionally to being stored in the buffer unit in the conventional way. The decoupling unit can be implemented, for example, as a dead plate or rest plate allowing the products to be temporarily stored for a predetermined waiting period. The rows are then pushed by a pusher or pushing means that revolves on a belt onto the transverse discharge belt or onto the discharge conveyor, in order then to be fed continuously and in uninterrupted fashion to a packaging machine by means of at least one conveyor—for example, a so-called gap-closing belt—following this belt or conveyor. As soon as the pushing action has been effected by the pusher or ejector, the row of products following on the main conveyor can again be loaded from the belt nose or delivery location of the main conveyor onto the rest plate that functions as a waiting area. If more product rows are arriving on the main conveyor than the packaging machine is able to package, the excess rows are transferred from the belt nose or from the delivery location of the main conveyor onto a vertically movable and/or swivelable loading belt or onto the loading conveyor. This movable or swivelable conveyor or belt enables the respective next free shelf of a gondola composed of a plurality of shelves or trays of the buffer unit to be loaded with a product row. In the event of higher production rates and/or if the packaging machine is stopped, all of the product rows must be temporarily stored in the buffer unit. To do this, the belt nose or delivery location of the main conveyor and the input location of the loading conveyor preferably move synchronously, vertically synchronized relative to the constantly upward-moving chain of the buffer on which the gondolas are transported that are provided with trays. Whenever a product row is loaded onto a gondola shelf or a tray, the belt nose of the main conveyor and of the loading conveyor move vertically down to the respective next free gondola shelf. They continue to move upward vertically synchronized with the chain of the buffer until a product row has been loaded onto the free product carrier shelf or gondola shelf. By way of example, 30 product rows, which are typically spaced uniformly relative to each other and are coming from the product station producing products, are transported on the main conveyor. This cycle rate is synchronous with that of the packaging station if, for example, 15 product rows per minute can be transferred from the main conveyor to the decoupling unit, and from this unit to the discharge conveyor. If, however, the packaging station has a different processing rate, the cycle rates are asynchronous relative to each other. Consequently, product rows can be transferred to the discharge conveyor only when this conveyor is free and ready to receive a complete product row. Product rows that are not fed through the decoupling device to the discharge conveyor are alternatively transferred from the main conveyor means via the loading conveyor to the buffer. If the flow of product rows coming from production has gaps, a product row can be pushed out at the optimal time onto the transverse discharge belt or the discharge conveyor by the pushing means of the decoupling unit. As a result, it is possible to supply the packaging machine with products in continuous interrupted fashion despite the gaps in the product flow. Whenever rows of products are no longer coming from production, the packaging machine can alternatively be loaded from the buffer in which a corresponding number of products has been pushed out by a push-out means or pushing means of the buffer unit onto the discharge conveyor. The result is that the buffer is gradually emptied over time.

One advantage of this product redistribution apparatus is the integrated waiting area for a product row. As a result, short-term independence from the production flow is achieved so that there is no need to first wait for the next row of products in order to load the discharge conveyor with products.

Another advantage of the product redistribution apparatus is that the requisite rows of products can be allocated for loading the packaging machine even during the highest production rates. Product rows that cannot be fed to the packaging machine are redistributed and fed to the buffer unit.

In one variant embodiment of the invention, the input location and delivery location of the buffer device of the product redistribution apparatus are stacked one above the other. One of the advantages of the invention is the fact that the input location and the delivery location of the buffer device are thus disposed on the same side of the buffer, thereby achieving a compact constructional design for the product redistribution apparatus. A particular advantage here is that the discharge conveyor of the product redistribution apparatus can receive products coming both from the buffer as well as directly from the production line, and convey them to a packaging station.

In one variant embodiment of the invention, the decoupling device of the product redistribution apparatus comprises a decoupling conveyor to temporarily receive and convey products between the input location and the delivery location, wherein the decoupling device comprises pushing means including at least one carrier by which the products received on the decoupling conveyor are able to be pushed out onto the discharge conveyor. One of the advantages of the invention is the fact that a row of products can be temporarily stored for a time or deposited on the decoupling conveyor. As soon as the discharge conveyor again has sufficient space to receive a new row of products, the decoupling conveyor is accelerated and the row is pushed onto the discharge conveyor. The row is pushed onto the discharge conveyor by a pushing means, such as, for example, one implemented as a thrust bar, in order to align the products in a row and to support the advance of the row on the decoupling conveyor. One advantage of this variant embodiment consists in the careful yet simultaneously efficient conveyance of products. It furthermore ensures that products can be pushed by the pushing means onto the discharge conveyor even if the decoupling conveyor is implemented as a simple plate or tray level.

In another variant embodiment of the invention, the loading conveyor of the product redistribution apparatus is swivelable about a swivel axis in the region of the input location, wherein the delivery location of the loading conveyor is positioned at one of multiple transfer positions so as to redistribute products at the input location of a corresponding tray level of the buffer unit. One of the advantages of the invention is the fact that the belt nose or the delivery location of the main conveyor can be positioned in a locally fixed fashion at a predetermined transfer position, while the loading conveyor is able to assume multiple transfer positions by swiveling the delivery location in order thus to transfer products to the corresponding trays or shelves of the buffer unit. In addition, it is possible for the loading conveyor to be able to track the motion of the conveyor chain or a corresponding shelf of the buffer unit. The loading conveyor also has a temporary buffering effect for at least one row of products.

In another variant embodiment of the invention, the loading conveyor of the product redistribution apparatus is designed to be height-adjustable, and the delivery location of the loading conveyor is positioned at one of multiple transfer or loading positions in order to redistribute products to the input location of a corresponding tray level of the buffer unit, wherein the input location of the loading conveyor is positioned correspondingly at one of multiple transfer positions with the delivery location of the main conveyor. One of the advantages of the invention is the fact that the products transferred from the main conveyor by the vertically movable loading conveyor are able to be fed at multiple positions to the buffer even if, for example, a rotary actuator cannot be implemented for the loading conveyor due to special space requirements. Even if generous space requirements are present, multiple trays can nevertheless still be loaded efficiently with products from one gondola or from the adjacent two gondolas of the buffer.

In another variant embodiment of the invention, the main conveyor of the product redistribution apparatus is permanently attached to the loading conveyor, wherein the swivelable main conveyor is designed to be longitudinally adjustable and is positioned at one of multiple transfer positions or loading positions. One of the advantages of the invention is the fact that a loading conveyor in the form of a special unit can be eliminated, for example, when producing small products and/or smaller production cycle rates. In the case of smaller products, for example, biscuits or small square chocolate bars, the loading conveyor is an integral component of the main conveyor. In other words, the main conveyor is augmented functionally by the features of the loading conveyor. The main conveyor of the product redistribution apparatus is thus permanently attached to the loading conveyor. The swivelable main conveyor is furthermore longitudinally adjustable so to allow the belt nose or the delivery location of the main conveyor to be positioned both at the decoupling device and also at the input locations of the buffer. Alternatively or additionally, any substandard product rows can be ejected by the movable belt nose of the main conveyor onto the auxiliary conveyance means. The main conveyor is also designed to be swivelable and longitudinally adjustable so as to be positionable at all of the required transfer positions, decoupling positions, loading positions, and/or secondary positions.

In another variant embodiment of the invention, the product redistribution apparatus comprises a secondary conveyor disposed transversely relative to main conveyance direction, wherein the delivery location of the main conveyor is positioned at another transfer position to redistribute products to the secondary conveyor. One of the advantages of the invention is the fact the rejection of bad product rows can be effected even during the highest production rates since the belt nose only needs to be retracted by the length of the product while the actual loading of the buffer is effected by the loading conveyor.

The following discussion describes the invention in more detail based on the exemplary embodiments depicted in the drawings. Additional essential features and advantages of the invention are revealed here based on the drawings and their description.

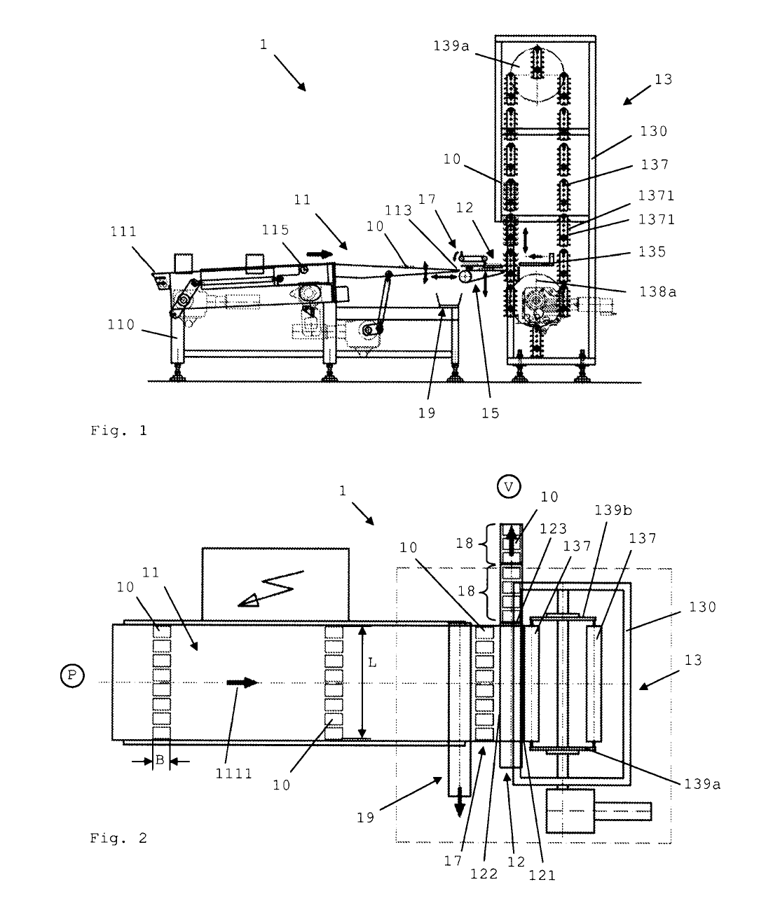

FIG. 1 is a schematic side view of the product redistribution apparatus according to the invention;

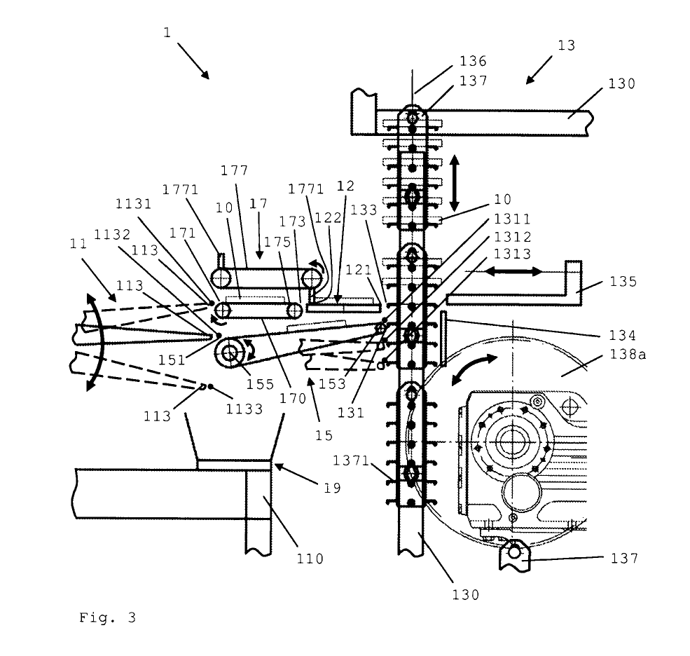

FIG. 2 is a schematic top view of the product redistribution apparatus;

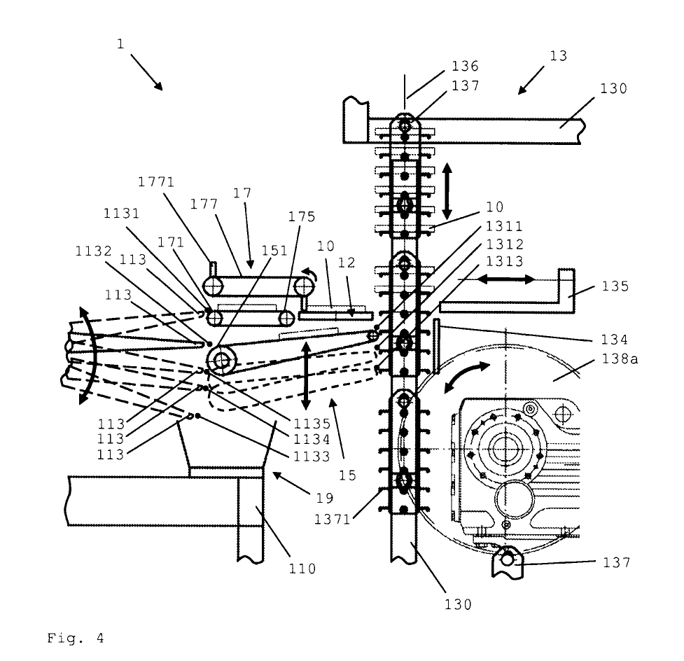

FIG. 3 depicts a detail of the product redistribution apparatus of FIG. 1;

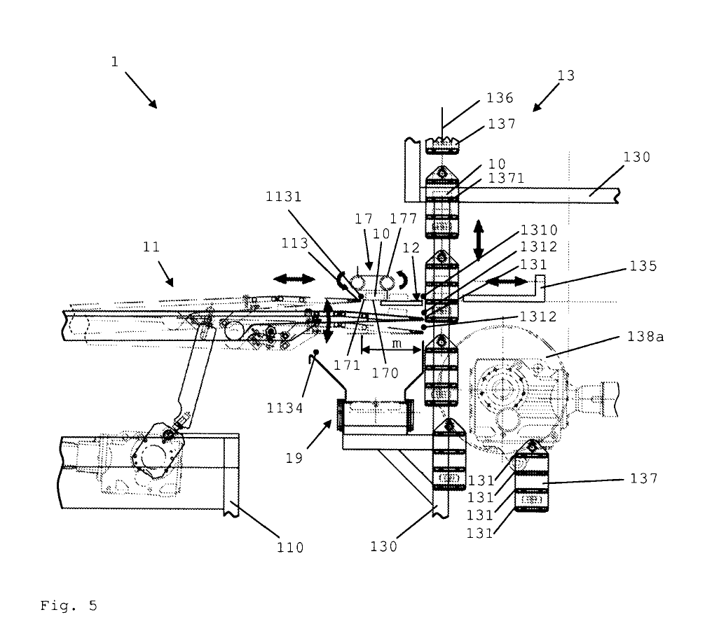

FIG. 4 is a schematic diagram of a variant embodiment of the product redistribution apparatus;

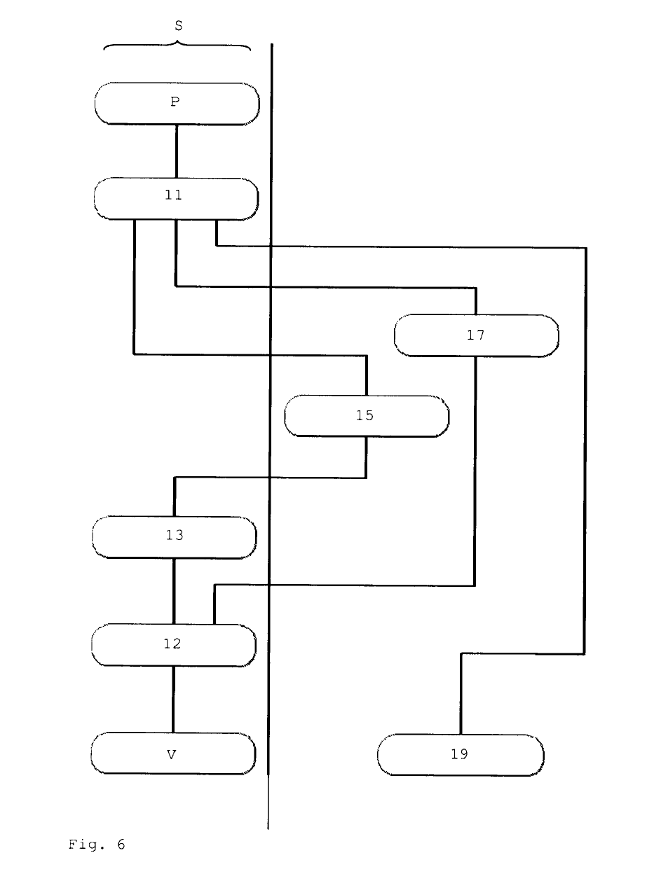

FIG. 5 is a schematic block diagram of another variant embodiment of the invention of the product redistribution apparatus; and

FIG. 6 is a schematic block diagram of the product redistribution apparatus.

FIG. 1 illustrates a product redistribution apparatus according to the invention that is identified by reference numeral 1. Product redistribution apparatus 1 includes a swivelably mounted main conveyor 11 to convey products 10 in a main conveyance direction 1111 between an input location 111 and a delivery location 113. Input location 111 can also be identified as an input edge, input, charging location, transfer edge, or the like. Input location 111 is understood to refer to the edge of the belt conveyor over its entire width at which the products are transferred in rows from an advancing production facility, which is not shown in FIG. 1. The swivel axis 115 runs perpendicular, approximately at right angles, to main conveyance direction 1111. Swivel axis 115 is preferably disposed approximately half-way between input location 111 and delivery location 113. However, the swivel axis can also be provided at input location 111. Delivery location 113 of main conveyor 11 is also identified as the output location, output, belt nose, or similar term. Main conveyor 11 is typically implemented as an endless belt or belt conveyor. The belt conveyor can also be designed to be longitudinal adjustable so that the belt nose is retractable. The drive for the belt conveyor is typically implemented using servomotors that are controllable or regulatable by a control means or regulation means. Various detection means or sensor means are typically disposed in main conveyor 11 in order, for example, to determine the exact position of products, in order detect metal residues in products, or the like. Drive means to swivel main conveyor 11 are also provided. It is possible to implement continuous swiveling. Various swivel positions can be implemented, for example, by controlling the swivel drive. The main conveyor is installed in a frame structure 110, generally a metal structure. FIG. 1 also illustrates a discharge conveyor 12, a buffer unit 13, a loading conveyor 15, a decoupling device 17, and a secondary conveyor 19 that is also identified as an ejection belt or the like. Buffer unit 13, which among other things is also identified as a product buffer, piece goods buffer, temporary buffer, gondola buffer, or buffer, is illustrated here as a first-in last-out buffer comprising a pair of chains, where each chain is arranged revolving around at least two sprockets 138, 139. The chains that run parallel to each other, although one chain is depicted here only from the side, include a driver means on which gondolas are releasably disposed. The gondolas 137 include multiple shelves or trays 1371 on which products 10 are deposited. The sprockets are mounted in the frame structure 130, usually a metal structure. At least one sprocket is driven by drive means, preferably a servomotor with gearing, and can be controlled by control means. The gondolas are typically transported cyclically, that is, in small steps, generally by the distance of shelf spacing. Shelf spacing refers to the distance between two trays of the gondolas. The drive can, however, also be implemented continuously and in stepless fashion. The continuous and the cyclical drives can be combined, thereby ensuring an alternatingly continuous or cyclical drive. Output and input of products from or into buffer 13 is effected as illustrated on the same side of the buffer. In this case, the output is disposed above the at least one input location. An essential aspect of this invention is the fact that one buffer 13 has one conveyance path by which, as illustrated, shelves 1371 of gondolas 137 run nearly vertically past loading conveyor 15 and past discharge conveyor 12. FIG. 1 also illustrates a pushing means 135 to push out products 10 from buffer 13 onto the discharge belt or discharge conveyor 12. The pushing means can be, for example, an elongated push rod or push bar that extends at least as far as length L. It is moved forward and backward by appropriate drive means, not shown here. The motion is controlled by control means of the corresponding drive. The push-out motion is coordinated with the presence of rows of products on discharge conveyor 12 or on decoupling device 17. The goal to be achieved is for discharge conveyor 12 to be continuously filled with products 10, thereby allowing products 10 to be discharged or carried away to be fed continuously and preferably uninterruptedly to a packaging machine, not shown. Decoupling device 17 comprises a conveyance means 170 that is implemented in the form of an endless rotating belt. Instead of an endless belt, a tray can also be provided. Products 10 that have been temporarily stored on the depositing surface or tray or the conveyor are moved at the appropriate time by pushing means 177, 1771 of decoupling device 17 onto discharge conveyor 12. In the meantime, the products are positioned “waiting” on this placement area. When a delivery location is connected to an input location, the term “connected” means that the delivery location of a conveyor, for example, the belt nose, is temporarily connected in noncontacting fashion to an input location of another conveyor or a placement area, preferably at the same level. The goal is to provide a transfer that is as careful as possible in handling products 10. For this reason, the connection between the relevant belts or trays is generally not coupled mechanically, thereby allowing belts and/or placement areas to be movable at any time relative to each other. This is true in particular whenever a tray, for example, tray 1371 of gondola 137 of buffer 13, is in motion and is being loaded with products 10.

In particular, the invention relates to a method for redistributing products 10 that are conveyed from a production station P producing products 10 to a packaging machine V for packaging products 10, and are temporarily stored between production station P and packaging station V, wherein temporarily stored products 10 are conveyed from an input location 13 of the buffer device to delivery location 133 of buffer device 13, wherein multiple trays 1371 are stacked vertically at the input location and/or at the output location, wherein the products are fed by main conveyor 11 of buffer device 13 from production station P at input location 131 to trays 1371, wherein temporarily stored products 10 at delivery location 133 of buffer device 13 are fed from trays 1371 to discharge conveyor 12 and are conveyed by this conveyor to packaging station V, wherein decoupling device 17 is provided that is disposed between main conveyor 11 and discharge conveyor 12, wherein products 10 of main conveyor are fed by main conveyor 11 either to decoupling device 17 or to the buffer device through redistribution, wherein products 10 are transferred by discharge conveyor 12 either from decoupling device 17 or from buffer device 13 and fed to packaging machine V in order to ensure an uninterrupted conveyance of products 10 to packaging machine V.

FIG. 2 provides a top view of product redistribution apparatus 1 according to the invention. Reference numeral 11 indicates the main conveyor on which two rows of products 10 can be seen. Discharge conveyor 12, which is disposed transversely relative to main conveyance direction 1111, accepts rows of products 10 from buffer unit 13 or from decoupling device 17. Reference numeral 17 provides a simplified view of the decoupling device on which a row of products 10 has been temporarily stored. Reference numeral 12 depicts the discharge conveyor on which no products have been deposited at this moment. In a next step, decoupling device 17 is driven in such a way that the temporarily stored product row is pushed by carriers, not shown, and the decoupling conveyor onto discharge conveyor 12. In addition, two gap-closing conveyors 18 are illustrated. These function to close gaps that result between individual successive rows of products. This is achieved by an approach where the gap-closing conveyors, generally endless rotating belts, are operated at least temporarily at different speeds. This is required in order to feed products at uniform spacing to the packaging machine that is disposed following gap-closing conveyors 18. FIG. 2 also depicts the two top sprockets 139a, 139b that are disposed parallel to each other. The bottom two sprockets are typically connected to each other by a drive shaft. Reference numerals 137 identifies two gondolas with shelves that are disposed on the chains of the buffer. The gondola chains can be driven forward and backward.

FIG. 3 illustrates a detail of product redistribution apparatus 1 of FIG. 1. The diagram shows a portion of swivelable main conveyor 11 with delivery location 113. Main conveyor 11 indicated by the broken line illustrates two additional positions at which the belt nose of delivery location 113 can be positioned. Main conveyor 11 is attached to frame structure 110.

A section of the buffer is indicated by reference numeral 13. Gondolas 137 are attached by carriers or cams, not shown, to chain the 136. The gondolas can be guided along frame structure 130, in particular, in the vertical transport direction for stabilization purposes. If the gondolas run around the sprockets, they are typically disposed to swing freely. Reference numeral 134 indicates a product stop or stop means. This functions to stop products 10 conveyed from loading conveyor 15 onto corresponding tray or shelf 1371 so as to prevent these from passing over shelf 1371 and falling down. Three gondolas 137 are seen in FIG. 3 that are stacked vertically. Another gondola 137 is partially visible, this one being illustrated rotating around sprocket 138a. Products 10 are pushed out by a pushing means 135 of buffer device 13 onto discharge conveyor 12, where delivery location 133 of buffer device 13 is connected to first input location 121 of discharge conveyor 12. Input location 131 and delivery location 133 of buffer unit 13 are stacked one above the other. As a result, product 10 just deposited in buffer 13 can be conveyed upward by one cycle and then immediately pushed out onto discharge belt 12 by pusher 135. Typically, however, products are pushed out from buffer 13 based on the first-in last-out principle. Buffer device 13 can also be regarded as a device comprising multiple stacked tray levels 1371. For the sake of handling, multiple respective tray levels or shelves for temporarily storing products 10 are combined on gondolas and uniformly spaced vertically relative to each other.

It is also possible to employ other buffer systems in place of a buffer with rotating chains. What is important is that trays 1371 are able to be conveyed vertically past conveyance means 12 and 15.

The units loading conveyor 15, decoupling device 17, discharge conveyor 12, and secondary conveyor 19 are disposed between buffer 13 and main conveyor 11. Each of these units is mounted on one or more supporting structures, which are not, however, shown here for the sake of legibility. Buffer device 13 includes one or more input locations 131 to receive, and one delivery location 133 to delivery temporarily stored products 10.

Product 10 is visible on discharge conveyor 12. The two longitudinal sides of the discharge conveyor are used simultaneously as input locations. The discharge conveyor is preferably implemented in the form of an endless conveyor belt, equipped with the appropriate drive and control means. The discharge conveyor can be run both forward and backward. Conveyor belt 12 has a first input location 121 that faces buffer 13. This conveyor also has a second input location 122 that faces decoupling device 17 and is opposite the first input location. Discharge conveyor 12 is preferably disposed rigidly at a predetermined height above the mounting level. The function of the discharge conveyor is either to transfer products 10 received from buffer 13 or from decoupling device 17 in a continuous row at delivery location 123, as seen in FIG. 2, to following gap-closing conveyor 18, and thus to a packaging machine.

Product redistribution apparatus 1 comprises loading conveyor 15 to convey products 10 between an input location 151 and at least one delivery location 153. The loading conveyor, preferably implemented in the form of an endless belt conveyor, can be swiveled into different positions about swivel axis 155 that runs perpendicular to main conveyance direction 1111. Appropriate drive and control means, not shown, are provided for this purpose. Swiveling can be effected either continuously, or in steps or relatively large increments. Delivery location 153 is also identified, for example, as the output location, belt nose, or transfer edge. The belt nose can, for example, be positioned at additional transfer positions 1311, 1312, 1313 that are indicated by broken lines. The transfer positions are fixed in place if the transfer of products is effected when gondola chain 136 is stopped. However, the transfer positions can also be in motion when gondola chain 136 is driven by sprocket 138a, 138b. In this last case, belt nose 131 must track the motion of the gondola chain or of corresponding empty shelf 1371 of gondola 137. This is achieved by appropriate regulation or control means that regulate or control the drive.

Delivery location 153 of loading conveyor 15 is connected at one of transfer positions 1311, 1312, 1313 to input location 131 of buffer device 13 in order to transfer products to buffer 13. Belt nose 153 is illustrated here at transfer position 1311.

In addition, transfer positions are also defined for main conveyor 11. Input location 151 of loading conveyor 15 is connected at second transfer position 15 to delivery location 113 of main conveyor 11. Additional transfer positions are indicated by reference numerals 1131 and 1133. Main conveyor 11 here is indicated by a broken line. Delivery location 113 can be positioned at one of multiple transfer positions 1131, 1132, . . . , by swiveling the main conveyor.

Product redistribution apparatus 1 comprises decoupling device 17 including input location 171 to receive products 10 from main conveyor 11 at first transfer position 1131. This first transfer position 1131 is also identified as a decoupling position. Decoupling device 17 includes a delivery location 153 to delivery products. Here delivery location 153 of the decoupling device is connected to second input location 122 of discharge conveyor 12. A decoupling conveyor of decoupling device 17 is identified by reference numeral 170. Conveyor 170 is designed to temporarily receive and convey products 10 between input location 171 and output location 171. Decoupling device 17 comprises pushing means 177 including at least one carrier 1771 by which products 10 received on decoupling conveyor 170 can be pushed out onto the discharge conveyor. Pushing means 177 and conveyor 170 are typically accelerated synchronously so as to push the products as carefully and rapidly as possible onto the discharge conveyor.

Loading conveyor 15 of product redistribution apparatus 1 is disposed swivelably in the region of input location 151 about swivel axis 155. Delivery location 153 of loading conveyor 15 is positioned here at one of multiple transfer positions 1311, 1312, . . . in order to redistribute products 10 at input location 131 to a corresponding tray level 1371 of buffer unit 13. These transfer positions 1311, 1312, . . . are also identified as loading positions.

Product redistribution apparatus 1 comprises secondary conveyor 19, which is disposed transversely relative to main conveyance direction 1111, to convey products 10, wherein delivery location 113 of main conveyor 10 is positioned at another transfer position 1133 to redistribute products to secondary conveyor 19. Sensors are typically provided above the conveyor belt of main conveyor 11 in main conveyance direction 1111, in particular, metal detectors or a video camera, by which the products can be inspected for metal residues or bad positioning or defects, etc. The corresponding sensor signals are evaluated, for example, by a programmable control or regulation system or analogous equipment, and appropriate control data are generated. Based on the control data, it becomes possible to reject qualitatively unsatisfactory products or rows of products onto the secondary conveyor whereby delivery location 113 of the main conveyor is swiveled into corresponding transfer position 1133. This transfer position 1133 is also identified as a secondary position. Secondary conveyor 19 can also be implemented, for example, as a waste container or tiltable discharge plate.

FIG. 4 illustrates a variant embodiment of product redistribution apparatus 1 according to the invention. Loading conveyor 15 is designed to be height-adjustable and can be made to track multiple transfer positions 1311, 1312, . . . . The transfer positions can be designed as fixed or movable. Input location 151 and output location 153 of loading conveyor 15 are preferably made to track these transfer positions to the same extent in height. The corresponding drive equipment is not shown in FIG. 4. Electrically controllable linear motors, hydraulic cylinders, or the like, can be used. Output location 153 of loading conveyor 15 is positioned at one of multiple transfer positions 1311, 1312, . . . in order to redistribute products 10 to input location 131 of corresponding tray level 1371 of buffer unit 13. At the same time, input location 151 of loading conveyor 15 is positioned correspondingly at one of multiple transfer positions 1132, 1134, . . . with output location 113 of main conveyor 11.

FIG. 5 illustrates one variant embodiment of product redistribution apparatus 1 according to the invention that is used, for example, in the production of small products 10 at relatively low production cycle rates. Small products are, for example, biscuits or small square chocolate bars. Due to the small dimensions of products 10, supply plate 170 and discharge belt 12 can be relatively narrow. Due to the relatively narrow design of supply and conveyance means 170, 12 and the relatively small number of movements by the belt nose of main conveyor 11 per time unit, it thus becomes possible for either gondolas 137 or supply area 170 to be loaded by main conveyor 11 with products through the retraction motion. Loading conveyor 15 (FIG. 3) is an integral component of main conveyor 11, or the main conveyor is augmented by adding the function of loading conveyor 15. Main conveyor 15 of product redistribution apparatus 1 is thus permanently connected to loading conveyor 15. In this case of a permanent connection, a mechanical coupling of the conveyors is provided. However, main conveyor 11 can also be designed to implement the properties of both conveyors 11, 15 where loading conveyor 15 is eliminated. Essentially, main conveyor 11 must thus be longitudinally adjustable and swivelable so as to allow the belt nose or the delivery location 113 of main conveyor 11 to be positioned at all transfer positions 1311, 1312, . . . ; 1331, 1332, . . . . Swivelable main conveyor 11 is also longitudinally adjustable so as to enable belt nose 113 of main conveyor 11 to be positioned both at decoupling device 17 as well as the input locations of buffer 13. Just as previously, substandard rows of products 10 can be ejected by movable belt nose 113 of main conveyor 11 onto conveyor 19. Main conveyor 11 is swivelable and longitudinally adjustable so that it can be positioned at all required transfer positions. Main conveyor here must essentially be designed to be extendable by distance m. Distance m determines, amounts to at least the distance between input location 171 and one of the transfer positions identified by reference numerals 1311,1312,1313, . . . .

FIG. 6 provides a block diagram of product redistribution apparatus 1 according to the invention. Blocks P, 11, 12, 13, V shown to the left of the vertically drawn line are known from the prior art S. Blocks 15, 17, 19 to the right of the line interact with the known units as indicated by the connecting lines between the blocks.

### REFERENCE NUMERAL LEGEND

1 product redistribution apparatus
10 product(s)
11 main conveyor
110 frame structure
111 input location, receiving location
1111 main conveyance direction, conveyance direction
113 delivery location, output location, belt nose
113, 1132, . . . transfer location, transfer position
115 axis, swivel axis
12 discharge conveyor
121 first input location, first receiving location
122 second input location, second receiving location
123 delivery location, output location
13 buffer device
130 frame structure
131 input location, receiving location
1331, 1332, . . . transfer location, transfer position, loading position
133 delivery location, output location
134 stop
135 pusher, pushing means
136 chain, gondola chain, belt, belt
137 gondola, transport rack
1371 tray level, buffer level, shelf
138a, b sprocket, drive wheel
139a, b sprocket, drive wheel
15 loading conveyor
151 input location, receiving location
153 delivery location
155 axis
17 decoupling device, decoupling unit
170 decoupling conveyor, supply area
171 input location, receiving location,
173 delivery location, output location
177 pushing means
1771 carrier, stop
18 gap-closing conveyor, supply area
19 secondary conveyor, ejection belt
B width
L length
m spacing, distance
P production station, production machine
S prior art
V packaging station, packaging machine

1.-14. (canceled)

15. A product redistribution apparatus, comprising:
a main conveyor for conveying products in a main conveyance direction between an input location and a delivery location, comprising a buffer device that includes multiple stacked tray levels to receive the products at an input location and to deliver the temporarily stored products at a delivery location, wherein the input location of the buffer device can be positioned at one of the transfer positions, and wherein the products can be pushed out by a pushing means of the buffer device at the delivery location;
a discharge conveyor to receive the pushed-out products at a first input location and to deliver the products at a delivery location of the discharge conveyor, wherein the delivery location of the buffer device is connected to the input location of the discharge conveyor;
a loading conveyor to convey the products between an input location and a delivery location, and wherein the delivery location of the loading conveyor can be connected at one of multiple transfer positions to the input location of the buffer device to temporarily store the products on a corresponding tray level;
wherein the main conveyor is configured to be swivelable, wherein the delivery location of the main conveyor can be swiveled into multiple transfer positions; and wherein the delivery location of the main conveyor can be connected to the input location of the loading conveyor at one of the multiple transfer positions of the main conveyor; and
wherein that the product redistribution apparatus comprises a decoupling device including an input location to receive products from the main conveyor at a first transfer position and including a delivery location to deliver the products, wherein the delivery location of the decoupling device is connected to a second input location of the discharge conveyor.

16. A product redistribution apparatus according to claim 15, wherein the loading conveyor is swivelable about a swivel axis in the region of the conveyor's input location, wherein the delivery location of the loading conveyor is positioned at one of the transfer positions to redistribute the products at the input location of a corresponding tray level of the buffer unit.

17. A product redistribution apparatus according to claim 15, wherein the loading conveyor is configured to be height-adjustable and its delivery location is positioned at one of the transfer positions to redistribute products to the input location of a corresponding tray level of the buffer unit, wherein the input location of the loading conveyor is positioned correspondingly at one of the transfer positions with the delivery location of the main conveyor.

18. A product redistribution apparatus according to claim 15, wherein the swivelable main conveyor is configured to be longitudinally adjustable, wherein the delivery location of the main conveyor can be positioned at multiple transfer positions.

19. A product redistribution apparatus, comprising:
a main conveyor for conveying products in a main conveyance direction between an input location and a delivery location, comprising a buffer device that includes multiple stacked tray levels to receive the products at an input location and to deliver the temporarily stored products at a delivery location, wherein the input location of the buffer device can be positioned at one of the transfer positions, and wherein the products can be pushed out by a pushing means of the buffer device at the delivery location;
a discharge conveyor to receive the pushed-out products at a first input location and to deliver the products at a delivery location of the discharge conveyor, wherein the delivery location of the buffer device is connected to the input location of the discharge conveyor;
wherein the main conveyor is configured to be swivelable, wherein the delivery location of the main conveyor can be swiveled into multiple transfer positions;
wherein the delivery location of the main conveyor can be connected at one of multiple transfer positions of the main conveyor to the input location of the buffer device to temporarily store the products on a corresponding tray level;
further comprising a decoupling device including an input location to receive products from the main conveyor at a first transfer position and including a delivery location to deliver the products, wherein the delivery location of the decoupling device is connected to a second input location of the discharge conveyor;
wherein the swivelable main conveyor is configured to be longitudinally adjustable to connect the conveyor's delivery location to the input location of the decoupling device at one of multiple transfer positions of the main conveyor.

20. A product redistribution apparatus according to claim 15, wherein the input location and the delivery location of the buffer device are stacked one above the other.

21. A product redistribution apparatus according to claim 15, wherein the decoupling device comprises a decoupling conveyor to temporarily receive and convey products between the conveyor's input location and its delivery location, and the decoupling device comprises pushing means including at least one carrier by which the products received on the decoupling conveyor can be pushed out onto the discharge conveyor.

22. A product redistribution apparatus according to claim 15, wherein the product redistribution apparatus comprises a secondary conveyor to convey products, the secondary conveyor being disposed transversely to the main conveyance direction, and the delivery location of the main conveyor is positioned at another transfer position to redistribute products to the secondary conveyor.

23. A method for rearranging products by a product redistribution apparatus according to claim 15, wherein the products of the main conveyor are conveyed by the main conveyor in the main conveyance direction, and the delivery location of the main conveyor is positioned at the first transfer position in order to redistribute products onto the decoupling device, wherein after completion of the redistribution the products are redistributed by the decoupling device onto the discharge conveyor.

24. A method according to claim 23, wherein alternatively or additionally the products are also fed by the main conveyor to the loading conveyor and are stored by the conveyor in the buffer unit.

25. A method according to claim 23, wherein alternatively or additionally the delivery location of the main conveyor is positioned to feed products into the buffer unit correspondingly at one of the transfer positions.

26. A method according to claim 23, wherein products are pushed out by the pushing means of the buffer unit onto the discharge conveyor, wherein products present on the loading conveyor or the main conveyor are alternatively or additionally fed by the loading conveyor or the main conveyor to the buffer unit while the products are being pushed out of the buffer unit.
